(19) United States
(12) Patent Application Publication
(10) Pub. No.: US 2024/0039346 A1
(43) Pub. Date: Feb. 1, 2024

(54) Material Layer, Material Layer Stack for an Electric Machine and Method for Producing a Material Layer

(71) Applicant: Siemens Aktiengesellschaft, München (DE)

(72) Inventors: Carsten Schuh, Baldham (DE); Thomas Soller, Deggendorf, Bayern (DE); Rolf Vollmer, Gersfeld (DE)

(73) Assignee: Siemens Aktiengesellschaft, München (DE)

(21) Appl. No.: 18/255,988

(22) PCT Filed: Nov. 5, 2021
(86) PCT No.: PCT/EP2021/080765

§ 371 Date: Jun. 5, 2023

(30) Foreign Application Priority Data
Dec. 4, 2020 (EP) 20211810.5

(51) Int. Cl. H02K 1/02; B28B 1/00; H02K 15/02

(52) U.S. Cl. CPC H02K 1/02; B28B 1/001; H02K 15/02

(57) ABSTRACT

Various embodiments of the teachings herein include a material layer. The material layer may include: a first ply including a first material adjoined along its planar extent by a second material, and integrally bonded along a first connecting section, the first having a lower relative permeability μτ than the second; a second ply integrally bonded to the first and at least partially covering the latter on a planar side, the second ply including a third and a fourth material connected along a planar extent along a second connecting section, the region of the third material or the fourth at least partially overlapping the first connecting section; and a third ply including a fifth and a sixth material, arranged on the first ply on a planar side opposite the second ply. The fourth material and the sixth material comprise a matching substance material different in relative permeability from the second material.

### CROSS-REFERENCE TO RELATED APPLICATIONS

This application is a U.S. National Stage Application of International Application No. PCT/EP2021/080765 filed Nov. 5, 2021, which designates the United States of America, and claims priority to EP Application No. 20211810.5 filed Dec. 4, 2020, the contents of which are hereby incorporated by reference in their entirety.

### TECHNICAL FIELD

The present disclosure relates to materials for electric machines. Various embodiments of the teachings herein include a material layer, a material layer stack, an electric machine, and/or a method for producing a material layer.

### BACKGROUND

Screen printing or stencil printing constitutes a novel method for producing magnetic laminations for electric machines. In this connection, starting with metal powders, first of all a printing paste is produced, which is then processed by means of screen or stencil printing technology using a thick-film process to form a green body. The resulting green body is then transformed into a metallic structured sheet-like component by thermal treatment, e.g. binder removal and sintering. Technology of this type is for example known from WO2020011821 A1.

If, for example, the rotor or the stator of an electric machine is to consist of a plurality of functional groups and therefore of a plurality of materials, for example a non-magnetic support structure made of stainless steel and a soft-magnetic flux-carrying functional element such as an alloy of iron and cobalt, then the challenge is to produce multi-component laminations. In particular, the handling of the green bodies during the production of the lamination elements may require a high level of technical complexity because of their small thickness. In the production of electric machines, a multiplicity of such laminations are usually combined to form a laminated core, which is then wrapped with a metallic conductor. Laminations are usually punched out of a coil for such laminated cores. However, such laminations in principle have the same material properties over the entire surface, since they consist exclusively of one material.

The typical lamination or laminations do indeed serve to build up a laminated core in a rotor or in a stator of an electric machine. Due to the composite assembly from two different functionally effective materials and due to the production process, a lamination is not referred to at this juncture, but rather in a more general form the term material layer is used.

### SUMMARY

The teachings of the present disclosure provide a material layer and a material layer stack, an electric machine and a method for producing a material layer which, compared to the known methods, requires less effort for producing the green bodies and thus permits production to be more cost-effective. For example, some embodiments of the present disclosure include a material layer for an electric machine, the material layer (2) comprising a first ply (4) which comprises a first material (6) in a planar extent, which first material is adjoined along the planar extent by a second material (8), the two materials (6, 8) being integrally bonded to each another along a first connecting section (10) and the first material (6) having a lower relative permeability μτ than the second material (8), characterized in that the material layer (2) has a second ply (12) which is integrally bonded to the first ply (4) and at least partially covers the latter on a planar side (14) and which also comprises at least two materials, a third material (16) and a fourth material (18) which in turn are connected along a planar extent along a second connecting section (20), the region of the third material (16) or the region of the fourth material (18) at least partially overlapping the first connecting section (10), and a third ply (22) being provided, which comprises a fifth material (24) and a sixth material (26), and the third ply (22) being arranged on the first ply (4) on a planar side (28) opposite the second ply (12) in an analogous manner to the second ply (12), and the fourth material (18) and the sixth material (26) being the same material and differing in relative permeability from the second material (8).

In some embodiments, the third material (16) has a lower relative permeability μ_{τ} than the fourth material (18).

In some embodiments, the fourth material (18) and/or the sixth material (26) overlaps the first connecting section (10).

In some embodiments, the second material (8), the fourth material (18) and the sixth material (26) have a relative permeability μ_{τ} which is greater than 50.

In some embodiments, the first material (6), the third material (16) and the fifth material (24) have a relative permeability μ_{τ} which is less than 5.

In some embodiments, the first material (6), the third material (16) and the fifth material (24) have a tensile strength of more than 800 MPa, or more than 1000 MPa.

In some embodiments, the material layer (2) is substantially rotationally symmetrical.

In some embodiments, the second connecting section (20) runs in such a way that it forms undercuts (36) in the planar extent between the third material (16) and the fourth material (18).

As another example, some embodiments include a material layer stack for an electric machine, comprising a plurality of material layers (2) stacked one on top of another as described herein.

As another example, some embodiments include an electric machine comprising a material layer stack as described herein as part of a stator or rotor (40).

As another example, some embodiments include a method for producing a material layer (2), wherein a composite green body (44) of the material layer is produced by means of a screen printing process, comprising: printing a first green body (46) of a first material (6) on a substrate (48), printing a second green body (50) of a second material (8) on the substrate (48) such that an area of the substrate (48) that is free from the first green body (46) is printed and the first green body (46) lies on the second green body (50) so as to be in contact therewith along a first connecting section (10), and therefore a first ply (4) is produced, printing a third green body (52) of a third material (16) on the first green body (46) and on parts of the second green body (50) of the first ply (4), printing a fourth green body (54) of a fourth material (18) on the first ply (4) such that a second ply (12) with a second connecting section (20) is formed between the third green body (52) and the fourth green body (54), wherein the region of the third green body or the region of the fourth green body at least partially overlaps the first connecting section (10), and after which a heat treatment process (56) of the composite green body (44) depicted in this way then takes place.

In some embodiments, the region of the fourth green body (54) at least partially overlaps the first connecting section (10) and in that the fourth material (18) formed from the fourth green body has a relative permeability μ_{τ} which is greater than 50.

In some embodiments, before the heat treatment process (56) of the composite green body (44), the latter is detached from a substrate (48) and rotated such that the second ply (12) rests on the substrate (48), and a third ply (22) with a fifth green body (58) of a fifth material (24) and with a sixth green body (60) of a sixth material (26) is printed on the first ply (4) analogously to the second ply (12).

### BRIEF DESCRIPTION OF THE DRAWINGS

Further embodiments and further advantages of the teachings herein are explained in more detail with reference to the following figures. These are purely schematic embodiments which do not represent a restriction of the scope of protection. In the figures:

FIG. 1 shows a plan view of a material layer in the XY plane with two different materials in the XY plane,

FIG. 2 shows a cross section through the material layer from FIG. 1 in the YZ plane,

FIG. 3 shows a three-dimensional representation in schematic form of the material layer,

FIG. 4 shows a plan view of differently designed material layers with different connecting sections,

FIG. 5 shows a schematic cross-sectional representation of a material layer stack as part of a rotor for an electric machine, and

FIG. 6 shows a schematic sequence of the method for producing the material layer.

### DETAILED DESCRIPTION

Some embodiments of the teachings herein include a material layer for an electric machine, the material layer comprising a first ply which comprises a first material in a planar extent, which first material is adjoined along the planar extent by a second material. The two materials are integrally bonded to each another along a first connecting section. The first material has a lower relative permeability μ_{τ} than the second material. The material layer is distinguished in that a second ply is provided which is integrally bonded to the first ply and at least partially covers the latter on a planar side and which also comprises at least two material layers, namely a third material and a fourth material. It is also the case for the second ply that the third and the fourth material are connected along a planar extent by a second connecting section. The second ply is positioned in relation to the first ply in such a way that the first connecting section is at least partially overlapped by one of the two materials of the second ply, i.e. either by the third material or the fourth material. This means by implication that the first connecting section in the first ply does not run congruently below the second connecting section. There is an overlap of one of the two materials of the second ply over the first connecting section. The boundary line between the first and the second material is thus covered by one of the two materials of the second ply, i.e. by the third and the fourth material.

This arrangement serves to strengthen the first connecting section by overlapping the second ply and to make the material layer easier to handle, in particular in the state of a green body, i.e. in the unfinished state, in particular before a heat treatment or sintering process, which reduces the production costs. However, even in the finished state, a material layer produced in this way has both a higher flexural strength and a higher tensile strength than material layers and laminations from the prior art.

Also in contrast to known methods, namely the production of magnetic laminations for laminated cores, the material layer described has different material properties in its planar extent. The first material can be designed with high strength and can satisfy the mechanical demands imposed on the final component, while the second material of the first ply meets the high demands imposed on the magnetic properties of the material layer. The material layer described therefore involves a specific local design of the material properties in an integral component.

In some embodiments, the third material of the second ply has a lower relative permeability μ_{τ} than the fourth material, which is likewise located in the second ply. Thus, the second ply can also offer similarly locally variable material properties to the first ply. In particular, the fourth material, which in turn may cover the second material from the first ply in the second ply, has at least similarly good magnetic properties with a high relative permeability as this. This means that the materials lying above one another of the first and second ply each have similar properties, and therefore it may be that the first and the third material have particularly high strength and the second and the fourth material have good magnetic properties.

In some embodiments, a third ply is provided, which comprises a fifth material and a sixth material. The third ply is arranged on the first ply on a planar side opposite the second ply in an analogous manner to the second ply. The third ply leads to further stabilization of the first ply on the opposite side of the second ply. The third ply also has a third connecting section and one of the two materials of the third ply overlaps the first connecting section of the first ply in an analogous manner in order to increase the stability of the first ply. In this case, therefore, either the fourth material and/or the sixth material overlaps the first connecting section.

In some embodiments, the connecting section to be overlapped by the fourth and sixth material, since the fourth and sixth material have good magnetic properties and the diffusion of the material components of the fourth and sixth material into the first material has a less sensitive effect on the properties thereof than the diffusion of the third and fifth material into the second material. The material properties of the second material, which has the high relative permeability, in particular of more than 50, are more sensitive to possible diffusion processes from the materials of the second and third plies than the first material. It is therefore more expedient to allow the material with the better magnetic properties, i.e. the fourth and the sixth material, to overlap the first connecting section of the first ply.

In contrast to the second, fourth and sixth material, the relative permeability of the third and fifth material and of the first material, i.e. the material which is intended to provide high strength, is lower, in particular lower than 5. Conversely, the first, the third and the fifth material have a very high tensile strength, in particular a high tensile strength of more than 800 MPa, or more than 1000 MPa.

In principle, the first, the third and the fifth material can have the same composition. They then also originate from the same starting material for the screen printing process. The same applies to the second, the fourth and the sixth material, which can also have the same material properties. However, in order to produce a gradient over the first, the second and the third ply with respect to the material properties, it can be expedient for the material properties of the first, third and fifth material and of the second, fourth and sixth material to differ slightly and change in the form of a gradient.

In some embodiments, the material layer has a substantially rotationally symmetrical structure and is therefore suitable for use in a rotor for an electric machine.

The specialist terms used here are defined as follows. The material layer corresponds functionally to a lamination in a conventional laminated core, for example of a rotor or a stator of an electric machine, for example an electric motor or a generator. Since the material structure and the production process differ from a conventional lamination, the term material layer is used instead of lamination. Instead of a laminated core, reference is made here analogously to a material stack which functionally corresponds with improved properties to a conventional laminated core.

The material layer is a planar structure that has a substantially greater extent in an x-y plane of a coordinate system than in a z direction. Therefore, the term planar extent is understood to mean an extent of the material layer in the x-y plane. At the ends of the extent of the first material, end faces that ideally run perpendicular to the x-y plane, i.e. in the z direction, are produced. In practice, the end faces are generally not perpendicular due to wetting effects and surface effects, but still have a substantial component in the z direction. The first material and the second material adjoin one another at their respective end faces and are integrally bonded to each another there. The course of the end faces at which the two materials are connected is referred to as the connecting section, when viewed from the z direction. Also when viewed from the z direction, the planar side of the first ply then extends in the x-y plane, with the planar side being substantially larger in its extent than the end face.

In this context, integrally bonded means connections in which the connection partners are held together by atomic or molecular forces. At the same time, they are non-detachable connections which can only be separated by destruction of the connection. Integrally bonded connections can be achieved, for example, by diffusion processes, sintering processes or by chemical reactions.

The permeability μ is determined by the quotient of the magnetic flux B and the magnetic field H. The relative permeability μ_{τ} in turn arises from the ratio of the measured permeability p and the vacuum permeability μ₀. Accordingly, μ_{τ} is a dimensionless quantity.

Some embodiments include a material layer stack for an electric machine, comprising a plurality of material layers stacked one on top of another as described herein. Such a material stack corresponds to a laminated core already mentioned for the rotor or also for the stator of an electric machine, such as an electric motor or a generator. Correspondingly, an electric machine may include a material stack as described herein as part of a stator or a rotor.

Some embodiments include a method for producing a material layer, wherein a composite green body of the material layer is first of all produced by means of a screen printing process. First of all, a first material is printed on a substrate and dried, with a first green body being produced. Subsequently, a second material is printed onto, and dried on, the substrate such that an area of the substrate that is free from the first green body is covered and the first green body lies on the second green body so as to be in contact therewith along a first connecting section, and therefore a first ply is produced.

A third green body of a third material is then printed onto the first green body of the first ply. Furthermore, a fourth green body of a fourth material is printed onto the first ply such that a second ply is formed with a second connecting section between the third green body and fourth green body. In this case, the region of the third green body or the region of the fourth green body is arranged in such a way that the first connecting section is at least partially overlapped. A heat treatment process of the composite green body depicted in this way then takes place.

In some embodiments, the handling properties are improved during production, and the material layer itself also has greater strength because of the multi-ply process and the overlapping of the connection in the first ply.

In some embodiments, the region of the fourth green body at least partially overlaps the first connecting section and the fourth material formed from the fourth green body has a relative permeability μ_{τ} which is greater than 50. These advantages because of the locally designed material properties have also already been described with respect to the material layer. The material properties are already anticipated in the green body material, from which the actual material is made by heat treatment.

A screen printing process is understood to mean a process in which a viscous paste (screen printing paste) is pressed through a fine-meshed screen using a doctor blade or a comparable solid aid such that a layer of the paste remains adhering to a substrate. The screen can be provided with a stencil, and therefore a negative image of the stencil is produced on the substrate. The paste used contains the basic substance of the material to be produced. When the paste is applied to the substrate and dried, it is said to be in a green state. In the drying process, solvents in particular are removed from the paste layer in order to make the latter handleable. The green body may be detachable from the substrate. If, as described here, a plurality of green bodies with different material compositions are put together and/or mounted one above another in a plurality of plies, this is referred to as a composite green body. The substrate preferably has a very smooth surface; glass, metal, ceramics, plastics or composite materials are suitable as the substrate material. The heat treatment process can contain a plurality of steps even in the event of a plurality of temperatures and atmospheres using different process pressures. In particular, sintering processes occur, for example in the form of diffusion processes, as a result of which material of the green body is transformed into the final functional material.

Some embodiments include a method, according to which before the heat treatment process of the composite green body, the latter is detached from the substrate and rotated such that the second ply rests on the substrate, and a third ply with the fifth green body of a fifth material and with a sixth green body of a sixth material is printed on the first ply analogously to the second ply. The advantages of the third ply, which consist in ensuring further strengthening and an improvement in handleability during the process, have also already been explained with respect to the first material layer.

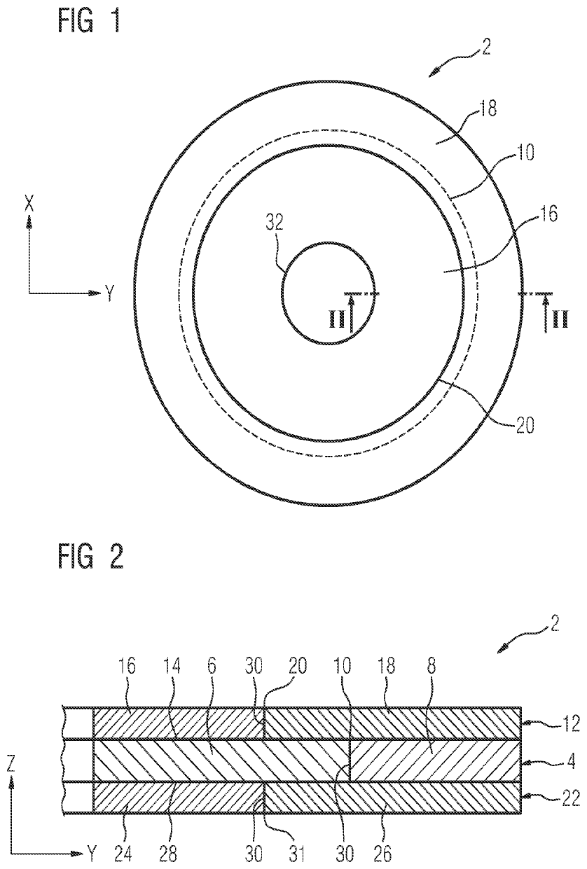

FIG. 1 shows a plan view of a material layer 2, which is shown in the planar extent in the xy direction. Section II indicated in FIG. 1 is reproduced schematically in FIG. 2 as a cross-sectional illustration. The cross section of the material layer 2 has a first ply 4 in the center, which is at least partially covered by a second ply 12 and a third ply 22 from above and from below in the illustration according to FIG. 2. The first ply 4 comprises a first material 6 and a second material 8. The second ply 12, which is arranged above the first ply 4 in the illustration according to FIG. 2, comprises a third material 16 and a fourth material 18. The third ply 22, which is arranged below the first ply 4, comprises a fifth material 24 and a sixth material 26. The second ply 12 is applied to a planar side 14 of the first ply and the third ply 22 to a further planar side 28 of the first ply 4.

The individual materials 6, 8, 16, 18, 24, 26 have different material properties. On the one hand, these relate in particular to the tensile strength and, on the other hand, to the relative permeability. The first material 6 has a relatively high tensile strength, e.g. above 800 MPa, or above 1200 MPa. Materials with a tensile strength of 1500 MPa and up to 4000 MPa are also expedient and feasible. In contrast thereto, the second material 8 has particularly good magnetic properties. The second material 8 has a relative permeability μᵣ, e.g., above 50, or more than 100.

The second ply 12 and the third ply 22 have similar material properties to the respective third material 16 and the fourth material 18 and to the fifth material 24 and sixth material 26, which material properties have already been described for the first and second material. The materials which are on the inside in terms of rotation, i.e. the third material 16 and the fifth material 24, may have a high level of strength analogously to the first material 6, and the materials which are on the outside in terms of rotation, i.e. the fourth material 18 and the sixth material 26, have good magnetic properties analogously to the second material 8. It can also be expedient for the first material 6, the third material 16 and the fifth material 24 to be configured on the same basis. The same applies to the second material 8, the fourth material 18 and the sixth material 26. Depending on the design, however, gradual differences in the material properties can also be set.

The first material 6 and the second material 8 lie on one another at end faces 30 connected in the XY plane, as already described in accordance with FIG. 1. The end faces 30 are shown perpendicularly in FIG. 2 with respect to the XY plane (FIG. 1) or with respect to the Y orientation in the Z direction. This is a clear simplification; in practice, such a perpendicular configuration of the end faces 30 will not be possible. A certain angle or else certain curved profiles of the end face 30 are real in practice. If the end faces 30 are transferred to the illustration in the XY plane according to FIG. 1, the end faces form connecting sections, namely a first connecting section 10 in the first ply 4 and a connecting section 20 in the second ply 12, and a third connecting section 31 in the third ply 22.

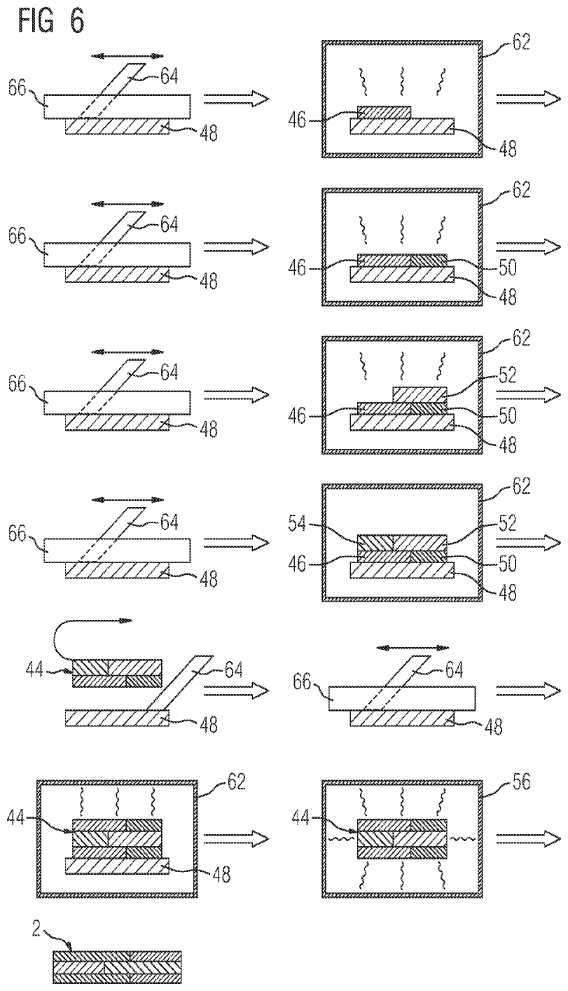

The connecting sections 10 and 20 can be seen better in FIG. 1 in the XY plane. Thus, the first connecting section 10, which lies in the first ply 4 and is superimposed by the second ply 12, is shown in dashed lines. The second connecting section 20 illustrates the separation in the second ply 12 between the third material 16 and the fourth material 18. The material layer 2 is preferably substantially rotationally symmetrical and has a bore 32, which will be discussed further with reference to FIG. 6.

The first connecting section 10 thus separates the first material 6 and the second material 8 along the end face 30. The second ply 12 and the third ply 22 are provided to increase the stability of the material layer 2. As already mentioned, the material combinations of the second ply 12 and the third ply 22 have similar properties to the first ply 4, and therefore a similar material in terms of tensile strength or magnetic properties is superimposed on the material of the first ply 4. Only in the border region, i.e. in the region of the connecting section 10, does the fourth material 18 in the second ply 12 overlap the first connecting section 10 in this embodiment according to FIG. 2 and FIG. 1. The fourth material 18 has similar magnetic properties to the second material 8. However, this fourth material 18 covers the connecting section 10 along the end face 30 of the first ply 4 and thus stabilizes said connection between the first material 6 and the second material 8.

The third ply 22 has the same effect with the sixth material 26 which overlaps the first connecting section from the opposite, second planar side 28 of the first ply 4. It is expedient here for the magnetic material, i.e. the fourth material 18 or the sixth material 26, to overlap the first connecting section 10 in such a way that the magnetic material lies against the first material 6 on the planar sides 14 and 28. If diffusion processes occur from the sixth material 26 or the fourth material 18 into the first material 6 during a heat treatment process, for example a sintering process, which will be discussed in more detail below, the good mechanical properties of said first material are in most cases less negatively affected than if diffusion processes were to occur between the third material 16 or the fifth material 24 and the second material 8. This is because materials with very high magnetic properties react more sensitively to alloy changes which occur as a result of diffusion processes.

In principle, it should be noted that diffusion barrier layers and/or adhesion-promoting layers (not shown here) are or can be applied to all boundary surfaces, i.e. on the end faces 30 and on the planar side 14 and on the planar side 28.

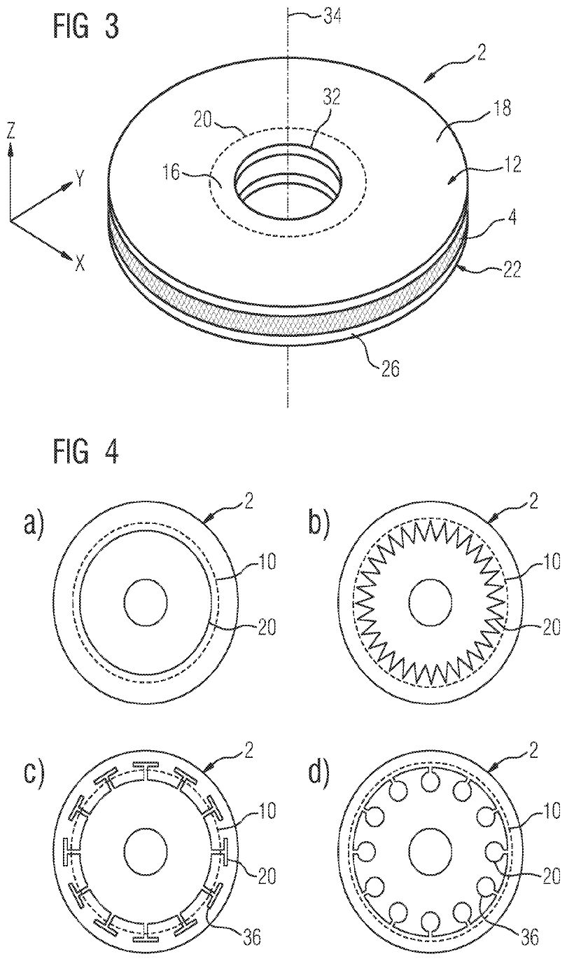

Analogously to FIGS. 1 and 2, FIG. 3 shows a three-dimensional illustration of a similar material layer 2, in which the coordinate system X, Y, Z is plotted three-dimensionally. The illustration according to FIG. 3 is used for better visualization of the illustration according to FIGS. 1 and 2 and it contains the features already explained with regard to said figures.

FIG. 4 indicates further configurations of the material layer 2 in respect of the shape of the connecting sections 10 and 20. The illustration analogous to FIG. 1 is shown in FIG. 4a. FIGS. 4b, 4c and 4d in turn differ in the arrangement of the connecting sections 10 and 20 to one other. Partial FIGS. 4b, 4c, and 4d have special profiles of the connecting section 20, with a star-shaped profile of the connecting section 20 in FIG. 4b being able to absorb in particular rotational shearing forces on the first ply 4 better than is the case in FIG. 4a. FIGS. 4c and 4d show undercuts of the connecting section 20 compared to the connecting section 10, which are particularly suitable for better counteracting centrifugal or centripetal forces acting on the material layer 2.

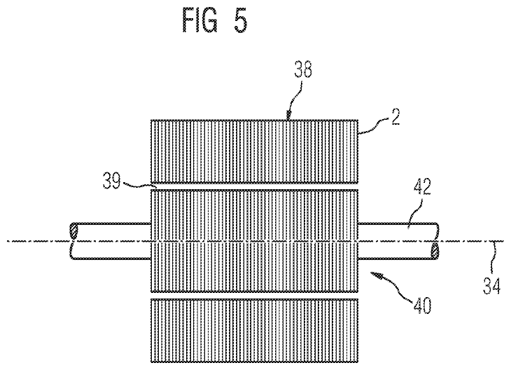

FIG. 5 illustrates a material layer stack 38 which is arranged on a shaft 42 which runs through the respective bores 32 of the material layers 2 and is movable rotationally along an axis of rotation 34. The material layer stack 38 or the respectively installed material layer 2 in detail has grooves 39 which have not been explained in the preceding figures. These grooves 39 are used for the arrangement of windings of an electrical conductor. The material layer stack 38 thus represents the base of a rotor 40 of an electric machine such as an electric motor or a generator. A material layer stack of this type is usually built up by stacking individual electrical laminations which have been punched out of a large metal sheet.

The difference over a conventional laminated core is, on the one hand, that the material layers used can be made significantly thinner than conventionally punched laminations. In some embodiments, the material layer here has a thickness of between 50 μm and 200 μm. Eddy current losses are reduced by thinner laminations, and therefore the material layer stack heats up less than a conventional laminated core. This in turn means that rotors 40 produced in this way can have a higher rotational speed until the limiting temperature for the electric machine is reached. The electric machine can thus be run at a higher rotational speed and thus also at a higher power.

The local material design already described comes into play so that the mechanical loads on the relatively thin material layers at higher rotational speeds can be withstood. In particular, the first material 6 of the first ply 4 has the high tensile strength described, and therefore even high centrifugal forces which act on the material layer 2 or on the material layer stack 38 at high rotational speeds can be endured. The composite representation of the material layer 2 with on the one hand a material of high strength and a material with very good magnetic properties can thus counteract the high tensile forces arising from the high rotational speeds. At the same time, the magnetic properties can be improved by a targeted selection of the second material 8 compared to conventional sheet metal materials.

A production process for the material layer 2 will be explained schematically below with reference to FIG. 6. This is one possible representation of the process, with it being possible for the material layer to also be produced by other process steps. In particular, the method description according to FIG. 6 does not claim to be complete. For example, additional method steps may also be introduced, such as the application of diffusion barrier layers or adhesion-promoting layers. For the sake of simplicity, these method steps will not be explained.

First of all, in a first step, as is shown at the top left in FIG. 6, a screen printing process is used, which is likewise shown here highly schematically and is illustrated only by a doctor blade 64, the direction of movement of which is indicated in two arrow directions, and by a screen 66. In this case, the doctor blade 64 is moved along the depicted double arrow by means of the screen printing process, with a paste, not shown here, being pressed through the screen 66. The paste comprises aqueous or organic solvents that are customary in screen printing technology, as well as binders, in particular organic binders, which are decomposed or evaporated again in further process steps. Furthermore, the paste comprises functional components, in particular metallic powders, which following a sintering process that is yet to be described have corresponding material properties. If the paste, not shown here, was pressed through the screen 66 onto a substrate 48 by means of the doctor blade 64 and then dried, a green body is formed on the surface of the substrate 48. The screen 66 may has different stencils, and therefore the paste is applied by the doctor blade 64 only where the screen 66 is permeable because of the stencil, which is not shown here.

In the top two illustrations of FIG. 6, a paste layer 46 of a first material 6 is first produced. This is preferably subjected to a drying process 62 so that said solvents can evaporate out of the paste. In a further step in the second row of FIG. 6, a second paste containing the basic substance for the second material 8 is now applied through a second screen 66. This creates a second paste layer 50 of the second material 8. This paste layer 50 is also returned to a drying process 62. Furthermore, according to the third row of FIG. 6, a paste layer 52 of the fourth material 18 is applied to the first ply which is thus produced and which corresponds to the first ply 4 of the material layer 2 in the final state.

A drying step 62 and a further application of a fourth paste layer 54 of the third material 16 follow. Next, it is expedient to detach the resulting green body assembly, which may also be referred to as a composite green body 44, from the substrate 48 and rotate said green body assembly. The third ply 22 is now applied in a manner analogous to the second ply 12, with a fifth green body 58 as a precursor of a fifth material and a sixth green body 60 as a precursor of a sixth material 26 being applied to the first ply 4. The object created in this way is referred to as a composite green body 44. Optionally, a further drying process 62 and a subsequent heat treatment process 56 take place.

In this case, temperatures leading to a sintering process of the composite green body 44 are used. The temperatures are between 800° C. and 1350° C., with diffusion processes and sinter neck formations as well as grain growth processes occurring between the individual particles present in the green body. Following the heat treatment process 56, the composite green body 44 is now called the material layer 2. The latter can optionally also be reworked or provided with coatings; for example electrically insulating coatings are expedient. A plurality of material layers 2 are then assembled to form the material layer stack 38 already described with reference to FIG. 5 and to assemble the rotor 40.

### LIST OF REFERENCE SIGNS

2 material layer
4 first ply
6 first material
8 second material
10 first connecting section
12 second ply
14 planar side
16 third material
18 fourth material
20 second connecting section
22 third ply
24 fifth material
26 sixth material
28 second planar side
30 end face
31 third connecting section
32 bore
34 axis of rotation
36 undercuts
38 material layer stack
39 grooves
40 rotor
42 shaft
44 composite green body
46 green body first material
48 Substrate
50 green body second material
52 third green body
54 fourth green body
56 heat treatment process
58 fifth green body
60 sixth green body
62 drying step
64 doctor blade
66 screen

What is claimed is:

1. A material layer for an electric machine, the material layer comprising:
a first ply including a first material in a planar extent, the first material adjoined along the planar extent by a second material, the two materials, integrally bonded to each another along a first connecting section, the first material having a lower relative permeability μ_{τ} than the second material;
a second ply is integrally bonded to the first ply and at least partially covering the latter on a planar side, the second ply including, a third material and a fourth material connected along a planar extent along a second connecting section, the region of the third material or the region of the fourth material at least partially overlapping the first connecting section; and
a third ply including a fifth material and a sixth material, the third ply arranged on the first ply on a planar side opposite the second ply in an analogous manner to the second ply;
wherein the fourth material and the sixth material comprise a matching substance material different in relative permeability from the second material.

2. The material layer as claimed in claim 1, wherein the third material has a lower relative permeability μ_{τ} than the fourth material.

3. The material layer as claimed in claim 1, wherein the fourth material and/or the sixth material overlaps the first connecting section.

4. The material layer as claimed in claim 1, wherein the second material, the fourth material, and the sixth material have a relative permeability μ_{τ} greater than 50.

5. The material layer as claimed in claim 1, wherein the first material, the third material, and the fifth material have a relative permeability μ_{τ} less than 5.

6. The material layer as claimed in claim 1, wherein the first material, the third material, and the fifth material have a tensile strength of more than 800 MPa.

7. The material layer as claimed in claim 1, wherein the material layer is substantially-rotationally symmetrical.

8. The material layer as claimed in claim 1, wherein the second connecting section forms undercuts in the planar extent between the third material and the fourth material.

9. A material layer stack for an electric machine, the stack comprising:
a plurality of material layers stacked one on top of another;
wherein each material layer of the plurality of material layers include:
a first ply including a first material in a planar extent, the first material adjoined along the planar extent by a second material, the two materials integrally bonded to each another along a first connecting section, the first material having a lower relative permeability μ_{τ} than the second material;
a second ply integrally bonded to the first ply and at least partially covering the latter on a planar side, the second ply including a third material and a fourth material connected along a planar extent along a second connecting section, the region of the third material or the region of the fourth material at least partially overlapping the first connecting section; and
a third ply including a fifth material and a sixth material, the third ply arranged on the first ply on a planar side opposite the second ply in an analogous manner to the second ply;
wherein the fourth material and the sixth material comprise a matching substance material different in relative permeability from the second material.

10. (canceled)

11. A method for producing a material layer including a composite green body of the the method comprising:
printing a first green body of a first material on a substrate;
printing a second green body of a second material on the substrate such that an area of the substrate free from the first green body is printed and the first green body lies on the second green body so as to be in contact therewith along a first connecting section, producing a first ply;
printing a third green body of a third material on the first green body and on parts of the second green body of the first ply;
printing a fourth green body of a fourth material on the first ply such that a second ply with a second connecting section is formed between the third green body and the fourth green body, wherein the region of the third green body or the region of the fourth green body at least partially overlaps the first connecting section;
applying a heat treatment process of to the composite green body.

12. The method as claimed in claim 11, wherein:
the region of the fourth green body at least partially overlaps the first connecting section; and
the fourth material formed from the fourth green body has a relative permeability μ_{τ} greater than 50.

13. The method as claimed in claim 11, wherein:
before the heat treatment process of the composite green body, the latter is detached from a substrate and rotated such that the second ply rests on the substrate; and
a third ply with a fifth green body of a fifth material and with a sixth green body of a sixth material is printed on the first ply analogously to the second ply.
